(19) United States
(12) Patent Application Publication
(10) Pub. No.: US 2008/0064008 A1
(43) Pub. Date: Mar. 13, 2008

(54) METHODS FOR THE VIRTUAL DESIGN AND COMPUTER MANUFACTURE OF INTRA ORAL DEVICES

(75) Inventor: Stephen M. Schmitt, San Antonio, TX (US)

Correspondence Address: HAYNES AND BOONE, LLP, 901 Main Street, Suite 3100, Dallas, TX, 75202, US

(73) Assignee: DENTAL IMPLANT TECHNOLOGIES, INC., San Antonio, TX (US)

(21) Appl. No.: 11/851,105

(22) Filed: Sep. 6, 2007

Related U.S. Application Data
(60) Provisional application No. 60/842,570, filed on Sep. 6, 2006.

(51) Int. Cl. A61C 5/00

(52) U.S. Cl. 433/140; 382/128

(57) ABSTRACT

A method is set forth for making a computer model of patient's jaws, teeth, soft tissues, pharyngeal airway, tongue, condyles, tempromandibular joints and associated structures and recording the relationship of these structures at specific positional orientations of the upper jaw to the lower jaw. This computer model allows for the virtual design of dental devices that are custom, one of a kind appliances using computer controlled milling or computer controlled layered manufacturing. The three dimensional (3D) data set of the patient's anatomy can be sent via the Internet to any health care provider involved in treatment and allows for visualization of the device prior to manufacture. Design changes can be made to the virtual device prior to its manufacture. The process revealed in this patent has specific utility in the construction of appliances for the treatment of sleep apnea and conditions affecting the temporomandibular joint or muscles of mastication.

### PRIORITY INFORMATION

This invention claims priority to and the benefit of the filing date of U.S. Provisional Application No. 60/842,570, filed Sep. 6, 2006, incorporated herein by reference.

### FIELD OF THE INVENTION

This invention has particular application to interocclusal devices and their design and manufacture. In some embodiments, the interocclusal devices are splints and in other embodiments, the interocclusal devices are devices for the treatment of obstructive sleep apnea.

### BACKGROUND OF THE INVENTION

Many patients experience problems resulting from improper positioning of the temporomandibular joint and associated musculature. This condition affects as much as 30% of the population. Patients can have many symptoms that include: headaches, popping or clicking of the joint, deterioration of the joint, grinding of the teeth, cracked or broken teeth and migration of teeth. Other patients have difficulty breathing during sleep due to a narrowing or closing of the pharyngeal airway. Intra oral devices that protrude the mandible forward and move soft tissue to open the airway can eliminate snoring and sleep apnea.

Unfortunately, the present method of making these intra oral devices is complex, and frequently a trial and error procedure must be used to determine the proper shape and form of the device for a given patient. Manufacturing the device is also a problem. In one method, autopolymerizing methyl methacrylate resin is added to a dental cast incrementally using the so called “salt and pepper” method. This is a common practice in the dental art. Unfortunately, this method creates many small air bubbles in the resin and the shape of the device is difficult to control. Another method of making the device is to carve a wax pattern of the appliance on the dental cast and then invest the pattern in dental stone to use the lost wax method to replace the wax with heat processed methyl methacrylate resin. This technique is called the “heat processed” method and results in a more dense resin but tends to be more distorted due to shrinkage of the resin, temperature changes and excess material trapped between the upper and lower member of the flask. Other methods have been used but they also result in problems. U.S. Pat. No. 6,082,995, which was issued to Wise on Jul. 4, 2000, uses a light cured octadecyl methacrylate composite to create the device but the material is brittle and still the form of the mold must be made by hand.

There is also a need in the art to be able to determine the positional relationship of the condyles to the fossae when a dental device is being planned and to be able to record and reproduce the movement of the patient's jaws such that the device can be made in harmony with the patients jaw movement and will not cause pain in the joint or muscles when it is worn. There is also a need in the art to be able to visualize the shape of the pharyngeal airway when the lower jaw is positioned prior to making a device for the treatment of sleep apnea. There is also a need in the art to be able to create dental devices from precise designs that eliminate the poor quality and distorted plastic parts created in the present art. There is also a need in the art to be able to send 3D data to dental laboratories or health care providers to determine the ideal form and design of the device before it is made and to allow for easy visualization, communication and changes of the design requirements before the device is made.

U.S. Non-provisional patent application Ser. No. 11/674,956, titled Method for Making a Virtual Computer Model of the Jaws, filed Feb. 14, 2007, incorporated herein in its entirety by reference, discloses a method of using computed tomography (CT) to image the hard and soft tissues of the head and neck. It also reveals a method of imaging the dental casts of a patient using non-radiographic techniques to eliminate radiographic scatter caused by dental restorations in CT scans. This present disclosure and the disclosure of U.S. application Ser. No. 11/739,310, filed Apr. 24, 2007, incorporated herein in its entirety by reference, reveal a method of tracking the positional relationship of the upper and lower jaw with static records (wax bites) average measurements and a digital recording device called ARCUSdigma digital recorder (KAVO Company). The methods revealed in these applications are used as the basis for creating the virtual models used in this invention.

The methods and devices disclosed herein may overcome one or more deficiencies in the prior art, including one or more of the deficiencies mentioned above.

### SUMMARY OF THE INVENTION

Briefly stated, the invention is directed to a system, including apparatus and method, for orienting data about a patient's jaws, teeth, soft tissue and supporting bone in a virtual computer model that eliminates radiographic scatter, use of a face bow and mechanical articulator. Once created, the virtual computer model can also incorporate movement from a digital recording device such as the ARCUSdigma (KaVo Company) or any other digital recorder that measures lower jaw movement in relation to the maxillary teeth or maxillae. This virtual model can also create motion of the lower jaw in relation to the upper by using known standard angulations and approximations for the distance of the teeth from the rotational centers. Many semi-adjustable mechanical articulators are designed with similar average or standard settings.

A radiolucent CT bite plate is used to record the position of the patient's teeth during CT imaging. The CT bite plate is rigid and has three or more non-linear radiographic markers imbedded in it. Bite registration material is placed on the bite plate and the patient bites into the material to record a specific jaw position. The bite plate has an extension that projects through the lips and extends vertically away from the plane of occlusion and laterally around and away from the soft tissues of the face. The radiographic markers can be detected in the CT image but do not create scatter. The bite plate is then used at the time of CT imaging to position the patient's teeth and jaws in a known relationship and to create radiographic images of the position of the bite plate in the CT scan.

A digital data set is also made of the patient's teeth and soft tissues using non radiographic imaging of the teeth and tissues with photographic, light, laser, holographic or any other imaging system that will record the teeth with an acceptable precision. Since the data sets for the upper and lower dental casts are known in relation to the mounting plates in the imaging system, data sets for the upper and lower casts can be moved in computer space such that the same three-dimensional orientation exists in computer space as existed when the bite plate was in the mouth or when the casts were joined with a wax bite record. This creates an accurate virtual computer model of the upper teeth and tissues in relation to the lower teeth and tissues in a specific static orientation.

In accordance with a preferred embodiment of the present invention, there is provided a method and appliance which relieves the adverse effects of improper jaw position on the temporomandibular joint and the musculature of the head and neck. There is also provided a method and device for the treatment of sleep apnea that positions the lower jaw such that breathing is improved, the pharyngeal airway can be visualized and the movement of the lower jaw can be in harmony with the device even as it repositions the mandible in a protrusive position.

In the preferred embodiment, the teeth, upper and lower jaws, temporomandibular joint, fossae, pharyngeal airway and planned device are all saved as 3D data sets that can be used with computer aided design (CAD) to design the intended device and to visualize it in computer space. These 3D data sets can also be sent via the Internet to other providers or laboratories to confirm the design or make changes. Finally, the data sets can be translated in to computer code to create the actual device using computer controlled milling or computer controlled layered manufacturing.

In some embodiments, the exemplary methods disclosed herein may include creation of a virtual computer model of a patient that allows for the visualization of the patient's teeth, temporomandibular joint, pharyngeal airway, and the dental device required to treat a specific problem.

In some embodiments, the exemplary methods disclosed herein may provide for virtual creation and design a specific dental device to be in harmony with the teeth, joints, muscles, pharyngeal airway and jaw movement.

In some embodiments, the exemplary methods disclosed herein may allow the dentist and laboratory technician to virtually reshape the device if needed prior to manufacture.

In some embodiments, the exemplary methods disclosed herein may allow the dentist and laboratory to visualize, communicate and change if needed, the actual 3D virtual plan for any given patient via the Internet.

In some embodiments, the exemplary methods disclosed herein may use advanced computer manufacturing techniques (milling and layered manufacturing) to make the device with minimal manual labor and improved physical qualities.

In some embodiments, the exemplary methods disclosed herein may include evaluating patient data via the Internet such that many individuals in different parts of the world can communicate and support the process of design and manufacture of dental devices.

In one exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth. The method also may include creating a virtual intra oral device interfacing with the teeth of the first virtual model, the virtual intra oral device having impressions formed therein to match the teeth of the first virtual model. The method also may include creating an actual intra oral device based on the virtual intra oral device.

In another exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth, and may include creating a virtual intra oral device interfacing with the teeth of the first virtual model of the patient's teeth, the virtual intra oral device having impressions formed therein to match the teeth of the first virtual model. Computer readable data representative of the virtual intra oral device may be transmitted to a manufacturing site; an actual intra oral device may be created based on the computer readable data.

In another exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth; creating a first virtual intra oral device interfacing with the teeth of the first virtual model, the virtual intra oral device having impressions formed therein to match the teeth of the first virtual model; creating a second virtual model of the patient's teeth, the second virtual model being the other of a model of the patient's upper teeth and a model of the patient's lower teeth; and creating a second virtual intra oral device interfacing with the teeth of the second virtual model, the second virtual intra oral device having impressions formed therein to match the teeth of the second virtual model; generating a virtual support for a connector on the first virtual model; and creating a first and a second actual intra oral device based respectively on the first and second virtual intra oral devices, the support being created to permit the connector to connect to both the first and the second intra oral devices.

In another exemplary aspect, this disclosure is directed to a device for treatment of sleep apnea. The device may include an upper piece shaped to securely receive upper teeth; a lower piece shaped to securely receive lower teeth; a connector extending from the upper piece to the lower piece, the connector being configured to limit the range of movement of the upper teeth relative to the lower teeth and to urge the lower teeth into a protrusive position relative to the upper teeth.

### BRIEF DESCRIPTION IF THE DRAWINGS

FIG. 1 is a schematic view of the lower cast attached to a reference plate in a digital 3D scanner.

FIG. 2 shows the preferred embodiment for determining the positional relationship of the upper cast to the reference plate on the scanner with a wax bite record.

FIG. 3 depicts the CT bite plate.

FIG. 4 illustrates the CT bite plate in the patient's mouth during the CT scan.

FIG. 5 shows the preferred embodiment for determining the positional relationship of the upper cast to the reference plate on the scanner with the CT bite plate.

FIG. 6 illustrates an exemplary process of making the virtual model of the patient.

FIG. 7 illustrates an exemplary process of making a virtual splint and manufacturing an actual one.

FIG. 8A, B and C illustrate virtual views of the upper cast, lower cast and virtual splint in viewing software.

FIG. 9 illustrates creating of a splint using computer controlled milling.

FIG. 10 illustrates the virtual model of the patient's face, CT bite plate, upper cast, lower cast, and pharyngeal airway in 3D computer space.

FIG. 11 illustrates the virtual lower jaw, upper jaw, condyle, temporomandibular joint, casts and pharyngeal airway.

FIG. 12 illustrates a virtual model of a patient with upper and lower offset pieces.

FIG. 13 illustrates the top and bottom view of the lower offset piece.

FIG. 14 illustrates upper and lower offset pieces with custom “Gothic Arch” movement cut into the lower offset piece.

FIG. 15 illustrates side views of the upper and lower offset pieces.

FIG. 16 illustrates an exemplary process of making a sleep APNEA device.

FIG. 17 is a block diagram of an exemplary system usable to accomplish the methods disclosed herein.

### DETAILED DESCRIPTION OF THE PREFERRED EMBODIMENT

For the purposes of promoting an understanding of the principles of the invention, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

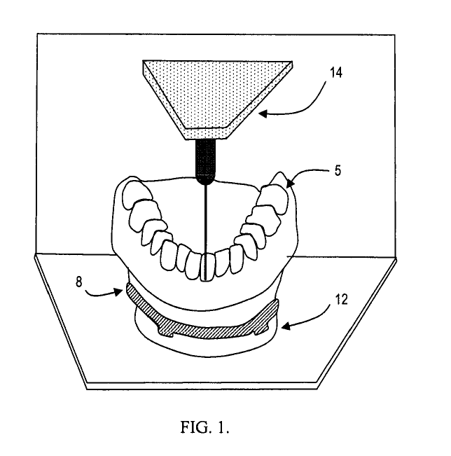

FIG. 1 illustrates a lower cast 5 joined to a mounting plate 8 seated in a mounting plate receiver 12. The cast is positioned in a digital imaging system 14 and can be imaged with contact, light, laser, radiographic or holographic imaging techniques. The imaging system creates a data set of the 3D surface of the dental cast in a known spatial relationship to the mounting plate receiver 12. The data can be stored in computer memory as a text file recording specific x, y and z points in relation to the mounting plate receiver or the points can be altered to produce a mathematical surface or solid model of the dental cast using mathematical algorithms known in the imaging art. A preferred method is to save the surface of the dental cast as a .stl (stereolithography) file which records the surface as a series of small triangles. The upper dental cast is imaged in the same manner to create a data set for the surface of the upper cast in relation to the mounting plate receiver.

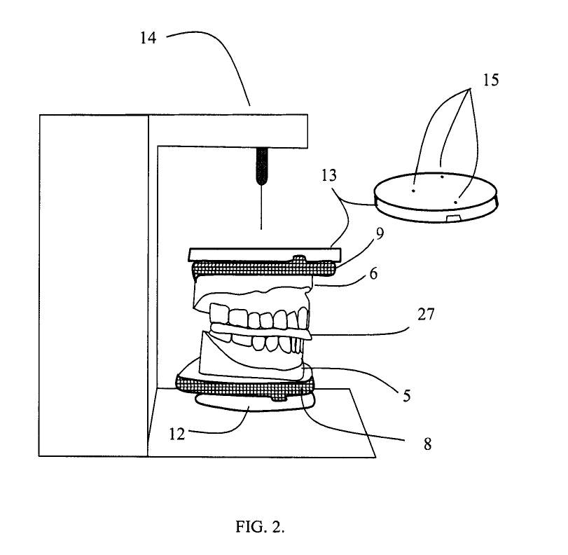

Turning now to FIG. 2 of the drawings, there is depicted the upper cast 6 and lower cast 5 on the digital scanner 14. The lower cast is seated in the mounting plate receiver 12 and the upper cast is held in position with a wax bite record 27. The bite record was made by the dentist and it records the orientation of the upper teeth to the lower teeth so that the casts can have the same orientation and relative position as the patient's actual teeth. The calibrating mounting plate receiver 13 is attached to the upper mounting plate 9. In FIG. 2, the calibration mounting plate is shown both on and off the cast. The calibrating mounting plate receiver 13 is used to record the spatial orientation of the upper mounting plate 9 to the scanner and its mounting plate receiver 12. The calibrating mounting plate receiver 13 has three small indentations on its surface 15 that can be detected with the scanner and are used to move the upper cast scan data in computer space using a three point move (Cadkey® Baystate Technologies Inc.). This will position scan data about the upper cast and bite record in the same orientation in the virtual model as exists in the patient's mouth.

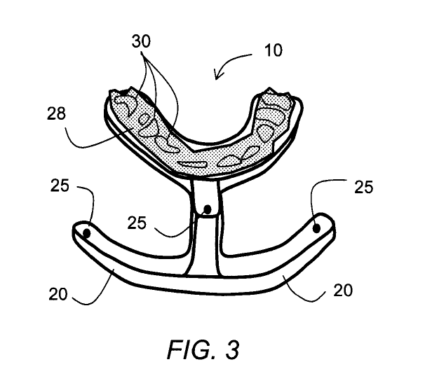

Referring to FIG. 3, there illustrates a CT bite plate assembly 10. The bite plate assembly has a U-shaped rigid section attached to a thin bite surface made of a radiolucent material that will mate with the patient's teeth and yet have minimal opening of the jaws. The bite surface has a central forward projection that extends between the lips when the assembly is placed in the mouth. The forward projection is joined to a vertical portion that extends above or below the plane of occlusion. Wings 20 extend laterally from the vertical portion and follow the contour of the face but do not contact it. Three or more non-linear radiographic markers 25 are attached to the vertical and wing portions of the CT bite plate. These markers have a radiographic density that makes them visible in the CT data and also have a geometric shape that can be imaged with contact, light, laser, or holographic imaging techniques. Bite registration material 28 records the indentations 30 of the upper and lower teeth when the patient bites into the CT bite plate.

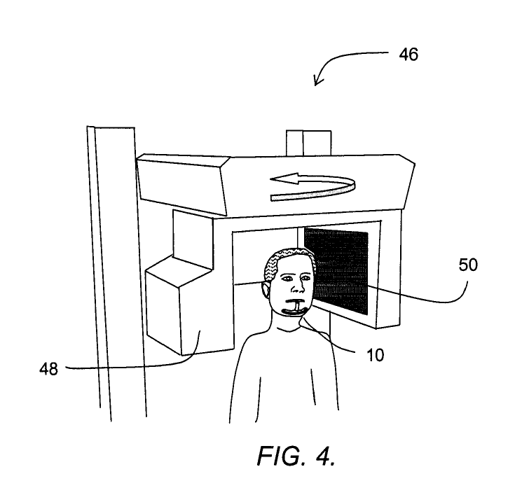

FIG. 4 illustrates the CT bite plate assembly 10 placed in the patient's mouth and the patient positioned in the CT machine 46. The x ray source 48 projects radiation across the patient's head and is detected on a sensor 50.

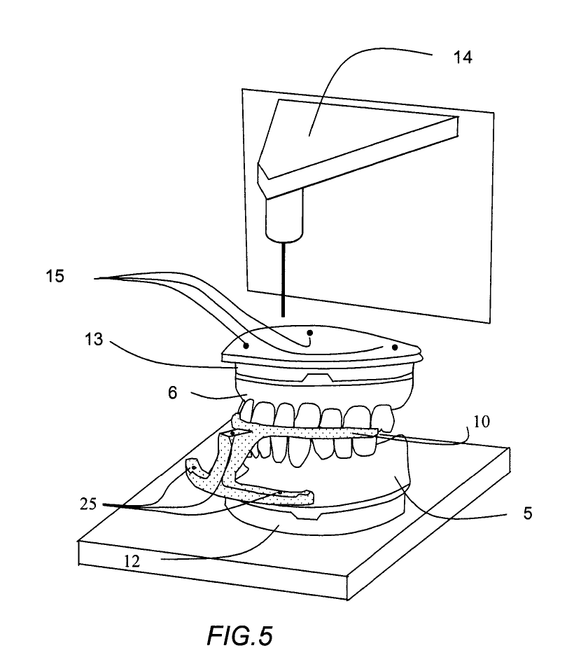

FIG. 5 illustrates the CT bite plate assembly 10 removed from the patient's mouth and attached to upper 6 and lower 5 dental casts on the imaging system. Because of the bite registration material, the teeth of the upper and lower dental casts can have a relative position that nearly identically matches that of the actual teeth recorded in the CT scan in FIG. 4. The position of the three radiographic markers 25 can be located and the location of the three indentations 15 on the calibration plate 13 can be used to record the orientation of the upper cast in relation to the lower. Data from the CT scan is saved as two dimensional grayscale bitmaps (DICOM format) and can be processed with volume rendering software to create 3D data sets of objects with specific grayscale values. Each object can then be saved as a 3D object in a known position in computer space. Since the dental casts were scanned in a different orientation in computer space, the three radiographic markers on the CT bite plate are used to move the orientation of the cast data to the same position as the CT data using a 3 point move in the CAD software. Many file formats are available to save the three dimensional shape of a give object. The preferred embodiment is the .stl (stereolithography) file. This is an efficient format that saves the surface of the object as small triangles in a known computer space.

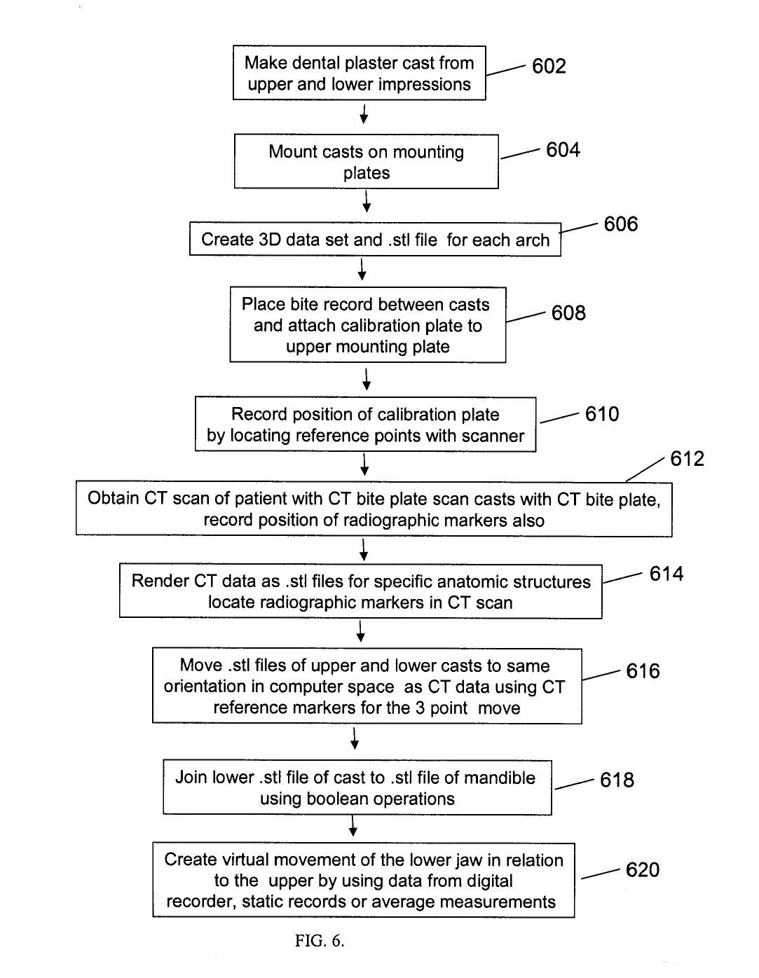

FIG. 6 illustrates an exemplary process of scanning the dental models and joining the scan data of the dental models to the CT data in the same spatial relationship. Portions of this process are disclosed in previously filed U.S. application Ser. No. 11/674,956, titled Method for Making a Virtual Computer Model of the Jaws, filed Feb. 14, 2007, incorporated herein in its entirety by reference.

As shown in FIG. 6, this process begins with a dental care provider, such as a dentist, technician, or other provider making a dental cast from upper and lower impressions as indicated at step 602. Once made, the provider mounts the casts on mounting plates as indicated at step 604 and creates a 3D data set and .stl file for each of the upper arch and the lower arch at step 606. This is explained above with reference to FIG. 1.

A bite record may be placed between the casts and a calibration plate may be attached to one of the upper and lower mounting plates at step 608. At step 610, the position of the calibration plate is recorded by locating reference points with scanner. As discussed above with reference to FIG. 2, the reference points may be indentations in the mounting plate or other reference points.

At step 612, a CT scan of the patient is taken, as shown in FIG. 4 and discussed in FIG. 4. The CT scan records data of the patient's actual anatomical structure in order to render a 3D image. In addition, at step 612, the casts are scanned with the CT bite plate in order to render a 3D image. The provider also may record the position of radiographic markers. One example of a CT bite plate is described with reference to FIG. 3 and shown between exemplary upper and lower casts in FIG. 5. The CT bite plate includes at least three radiographic markers that, when scanned and reproduced as a virtual image, may be used to align the casts in computer space to have substantially the same orientation and relative position as the patient's actual teeth.

At a step 614, CT data is rendered as .stl files for specific anatomic structures and for casts and the radiographic markers are located in the CT scan. At step 616, the provider manipulates .stl files of the upper and lower casts so that they have the same orientation in computer space as the CT data of the patient's anatomical structure. This is done by aligning the markers on the CT bite plate in the scan of the upper and lower casts with the markers on the CT bite plate of the CT scan of the patient. Aligning the three CT reference markers in computer space so that the scanned casts have nearly the exact position of the patient's teeth may be referred to as a 3 point move. It should be noted that prior to aligning the scans of the casts into position within the scan of the patient, the images of the patient's teeth may have been removed using a Boolean operation, and therefore may be replaced by the scanned cast images. Doing this eliminates the radiographic scatter that may have occurred when the patient was scanned, and replaces the scatter with images of the casts. Thus, the image is cleaner and provides more precision than if only the scan of the patient were used.

At step 618, the lower .stl file of the casts is joined to the .stl file of the mandible of the patient using Boolean operations. At step 620, virtual movement of the lower jaw relative to the upper jaw may be created using data from a digital recorder, static records, or average measurement. This data may have been obtained, such as when using the digital recorder, by scanning the patient's jaws while he or she moves the upper and lower jaws relative to each other, thereby tracking the pathway of relative movement. These recorders may include ultrasound, infrared, light and other methods of recording the positional relationships. The ARCUSdigma (KaVo Company) digital recorder may be ideally suited for this task. The movement data also may have been obtained by taking multiple static records of the patient's jaws in different positions relative to each other. The compilation of such static records may be used to create a pathway of jaw movement, allowing the provider to track the pathway of movement. In some embodiments, the pathways of movement may be determined by calculations based on size measurements and other data for the patient himself or for average data taken from a number of patients. These recorded, determined, and calculated pathways of movement are referred to herein as pre-determined paths of movement.

While some exemplary versions of the processes described above for obtaining 3D renderings include taking a CT scan of the patient, in other exemplary versions, only the casts are scanned. Therefore, the images of the casts are not placed with or aligned with an image of the patient. As described above, in some examples, these casts still may be oriented with a bite record allowing the 3D rendering of the top and bottom casts to be oriented relative to each other in the manner similar to the relative orientation of the patient's actual teeth.

Once the data is stored as a computer data file, the data can be used to create interocclusal devices, such as splints, for treatment of conditions such as bruxism and temporomandibular joint dysfunction syndrome. The data also may be useful in the design and manufacture of devices for the treatment of obstructive sleep apnea. Specifically, in designs that prevent obstruction of the pharyngeal airway and also allow movement of the upper and lower jaw in harmony with the patient's tempromandibular joint, ligaments and muscles.

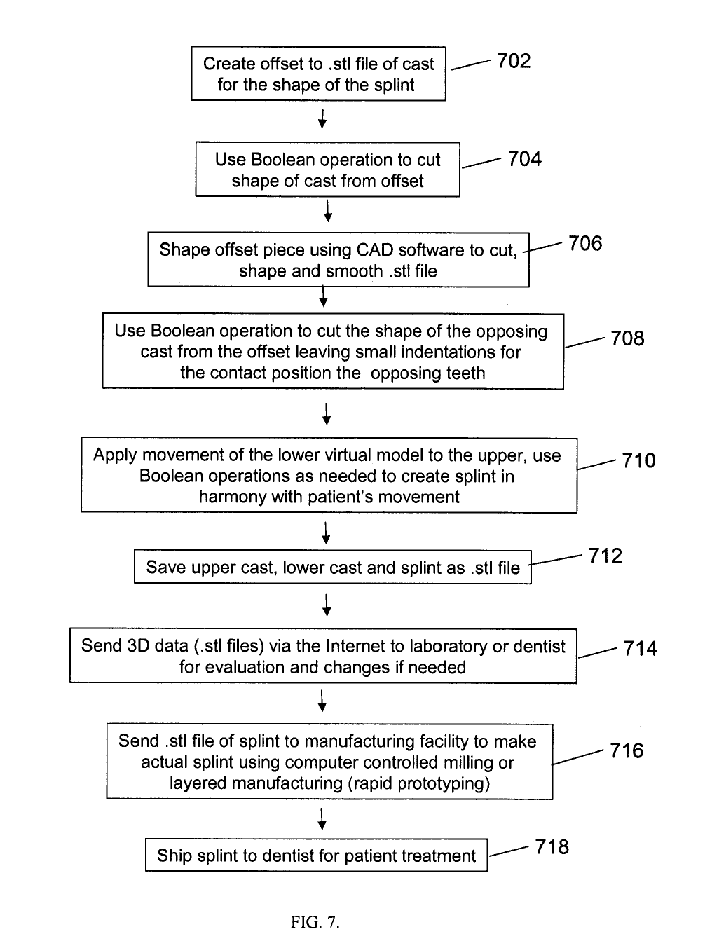

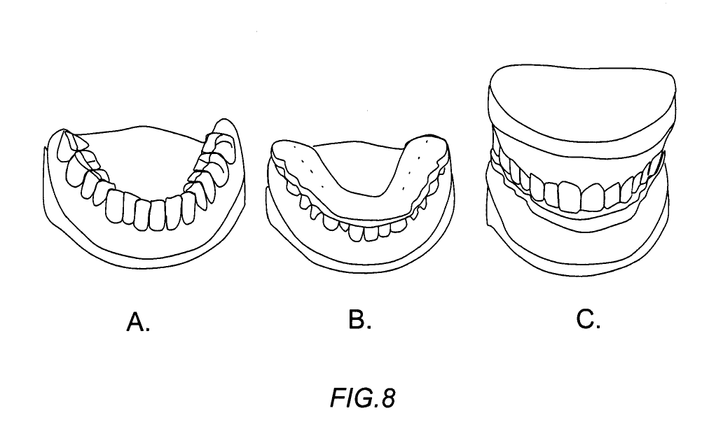

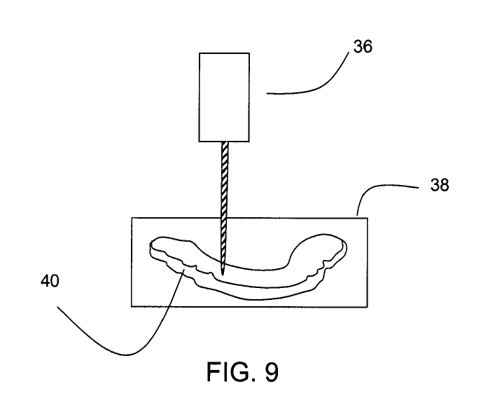

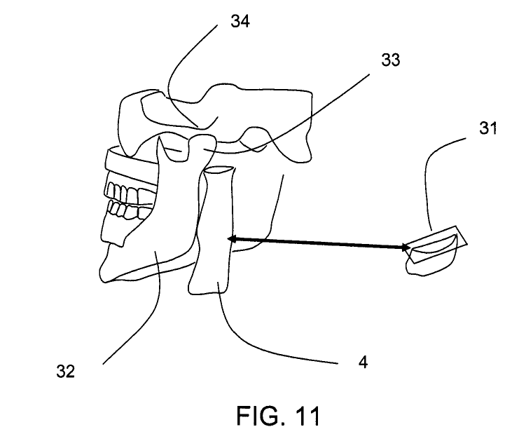

FIGS. 7-10 disclose an exemplary process for creating a splint and FIGS. 11-16 disclose an exemplary process and design for the treatment of obstructive sleep apnea. FIG. 7 is a flow chart of an exemplary process of creating a splint for a patient. FIGS. 8A-8C show images that will be discussed relative to the process in FIG. 7. These images are exemplary .stl files of the dental casts and also include the dental splint that is planned for a patient. Computer software such as FREEFORM™ (SensAble Technologies Inc.) allow for viewing and changing the shape of the .stl file using tools similar to objects in the real world. The created splint, therefore, can be easily smoothed or cut to fit to the opposing teeth or modified in any way and then saved as a new .stl file. FIG. 9 illustrates an exemplary process of physically manufacturing the splint 40, once the virtual splint is created.

Turning now to FIG. 7, a flow chart shows an exemplary process of creating a virtual splint and the method of sending the 3D data about the splint via the Internet to other individuals in the treatment process. It also indicates the method of manufacturing the splint.

At a step 702, a user may create an offset to the cast image from the .stl file. In some exemplary embodiments, the offset is performed using a CAD command to expand the teeth in each dimension, such as, for example, upward and outward. In other exemplary embodiments, the offset is made by extruding the cast image, such as an upward extrusion of the image of the teeth and gums. The offset, after additional processing an shaping, ultimately is used to create a 3D computer rendered image of the splint. FIG. 8A illustrates one exemplary image of the lower dental cast viewed in the software prior to the offset step 702.

At a step 704, the user may cut the shape of the cast from the offset using a Boolean operation. Because the offset portion is above and/or around the cast teeth, removing the cast portion from the offset portion leaves negative impressions of the teeth in one of the surfaces of the offset portion. This offset portion, now removed from the image of the cast, ultimately becomes the splint for placement between a patient's upper and lower teeth. Once finished and actually produced, in some embodiments, these negative impressions are shaped to receive the patient's actual teeth deeply enough to secure the splint onto the actual teeth limiting the relative movement of the actual teeth and the splint.

At a step 706, the offset piece is shaped using CAD software to cut, shape and smooth the image of the .stl file to form the splint. FIG. 8B shows one example of a splint on the lower virtual cast. Although not shown in FIG. 8B, the splint includes negative impressions that receive the teeth of the lower cast (and when physically created, will receive the patient's actual teeth).

At a step 708, the user may use Boolean operations to cut the shape of the opposing cast (which in FIG. 8 is the upper cast) from the offset leaving small indentations for the contact positions of the opposing teeth. Here, it is contemplated that the small indentations are not sized necessarily secure the opposing teeth in place on the splint. Instead, the opposing teeth may be provided with the freedom to move and displace relative to the offset piece, providing protection for the teeth without creating discomfort or muscle fatigue. Nevertheless, the indentations to provide an indication of, for example, a proper position or an ideal position, thereby maintaining the jaws and surrounding muscles in a comfortable position. In alternative embodiments, the small indentations are recessed indentations sized to secure the teeth into position.

At step 710, the virtual model of the upper cast may be moved relative to the virtual model of the lower cast in the manner that the patient's actual upper teeth move relative to the lower teeth. These movements may follow the movement recorded or calculated as described above in step 620 of FIG. 6, and further detailed in U.S. application Ser. No. 11/674,956. Boolean operations may be used as needed to create the splint to in harmony with patient's movement, meaning that the splint allows or facilitates these relative movements. This helps avoid jaw stress and muscle fatigue that may otherwise occur. FIG. 8C shows one example of the virtual splint located between the upper and lower virtual casts. As shown, the upper teeth rest substantially on the splint, while the lower teeth may be received into indentations extending into the splint.

At a step 712, the upper cast, lower cast and splint are saved as an .stl file (3D data file). At a step 714, the 3D data file is sent via the Internet to a separate location, such as a separate laboratory or dentist, for evaluation and changes if needed. In some exemplary embodiments, the file is not sent to an offsite location, but is stored for access by a remote user, such as the laboratory or dentist. This access may be made using for example, the Internet or other network. Accordingly, at step 714, the data is made available to an additional user for review and editing.

At step 716, after review and approval by the dentist, the .stl file of the splint is sent to a manufacturing facility to make the actual splint. The actual manufacturing may be accomplished using any suitable method, but in some embodiments, may be manufactured using programmable CNC machinery, such as a computer controlled mill, or using layered manufacturing (rapid prototyping). Once properly manufactured according to the specifications of the .stl file, the splint is shipped to the dentist for patient treatment at step 718.

FIG. 9 illustrates manufacturing of the splint, which is referenced by the numeral 40. The .stl file of the designed splint 40 may be received by the manufacturer and translated into code to run an industrial mill 36. The splint 40 may be machined from a block of material such as Plexiglas® 38 (methyl methacrylate resin) to have the same shape as the virtual splint. Other materials also are contemplated.

In some examples, the splint may be manufactured using computer controlled layered manufacturing (rapid prototyping). With this technology the splint is built a layer at a time using a stereolithography machine or a similar method that creates the part from CAD data. Other manufacturing tools and machines also may be used.

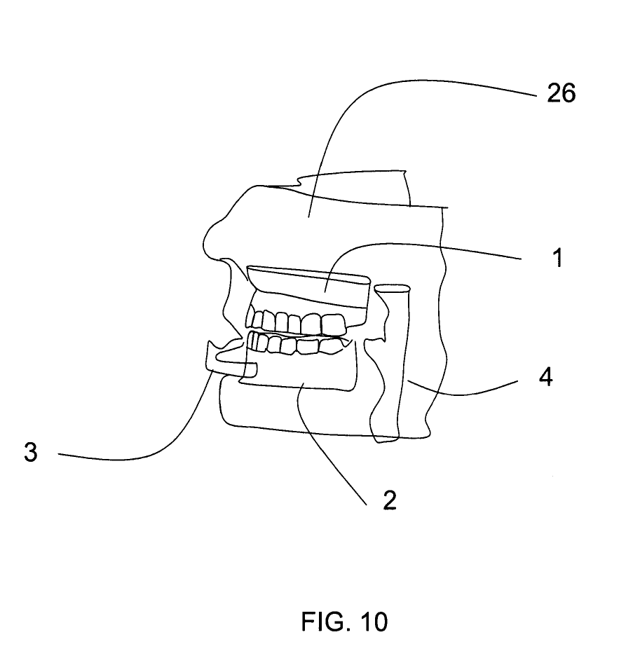

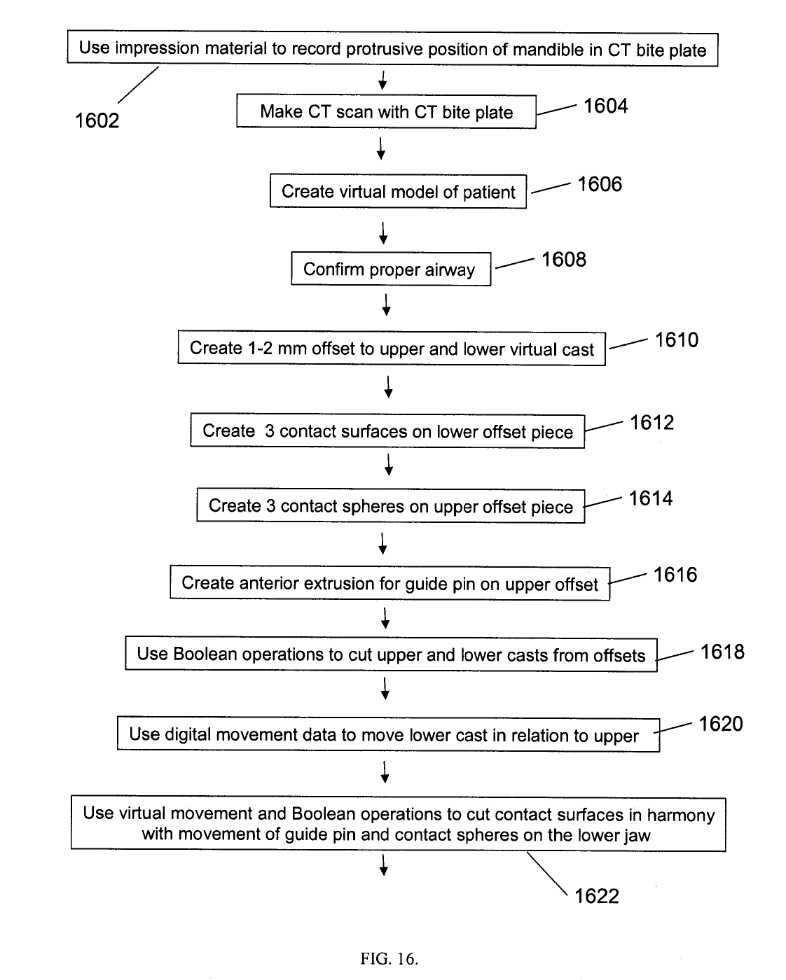

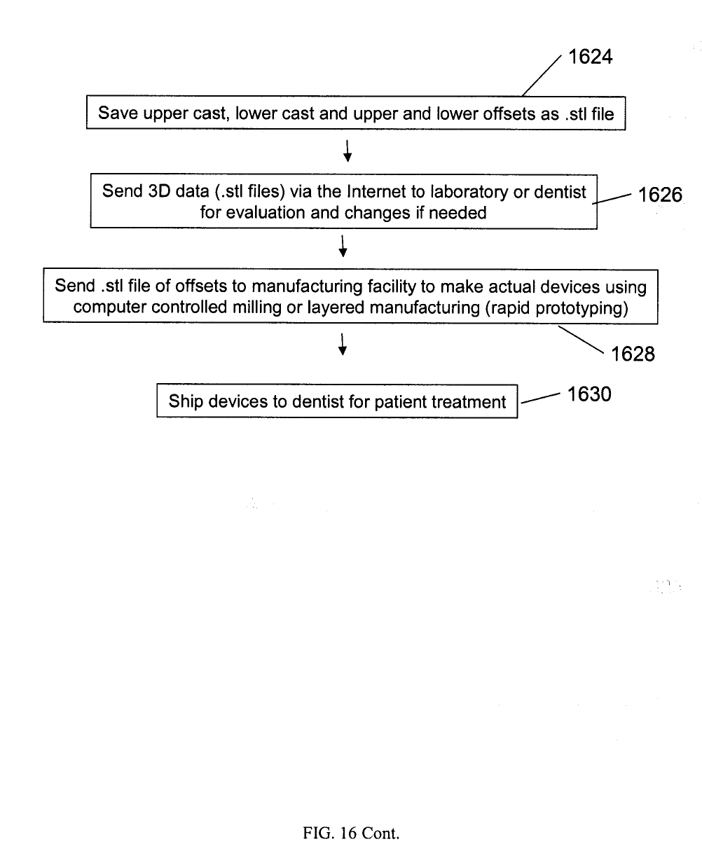

As mentioned above, FIGS. 10-16 disclose a sleep apnea device and a method for its manufacture. FIG. 16 discloses an exemplary process of generating a virtual model and an actual physical model of the sleep apnea device. This disclosure will first discuss the process in FIG. 16, and discuss the additional disclosure of FIGS. 10-15 relative to the steps in FIG. 16.

Referring to step 1602, a user uses impression material to record a protrusive position of the mandible in the CT bite plate. This includes orienting the jaw to be in the desired protrusive position to treat the sleep apnea. With the CT bite plate in place and the mandible in the desired protrusive position, at step 1604, a CT scan is taken and the images are stored as .stl files. Taking the CT scan is discussed in FIG. 4 above.

At step 1606, a virtual model of the patient is created. Using the scanned data, images can be created as shown in FIGS. 10 and 11. FIG. 10 illustrates a view of the .stl files from the CT scan in 3D computer space. In FIG. 10, the virtual model of the upper cast 1 and lower cast 2 can be seen in relation to the face 26 and virtual CT bite plate 3. The pharyngeal air way 4 is shown in the scan and can be viewed from any angle to determine if adequate space is available for breathing when the lower jaw and teeth are in the recorded position.

At step 1608, the user confirms the proper airway. FIG. 11 illustrates the virtual pharyngeal airway 4 and a cross sectional view of the airway at the level of the mandible 31. The mandible 32 and the positional relationship of the condyle 33 to the temporomandibular fossae 34 can also be visualized and measured. Confirming the proper airway allows the user to determine whether the protrusive position is properly treating the apnea condition. If the airway is not properly opened, the protrusive position may be adjusted and the scanning process may be re-performed until a position is found that properly opens the airway.

At a step 1610, an upper offset is created relative to the upper virtual cast and a lower offset is created relative to the lower virtual cast. As discussed above with respect to FIG. 7, the offset may be an expansion of the image surfaces in more than one direction or may be an extrusion of surfaces. For example, the upper and lower offsets may be shaped and sized to encapsulate the respective teeth of the virtual upper and lower casts. In one example, the offset is 1 to 2 mm offset, however, other offset distances or amounts are contemplated.

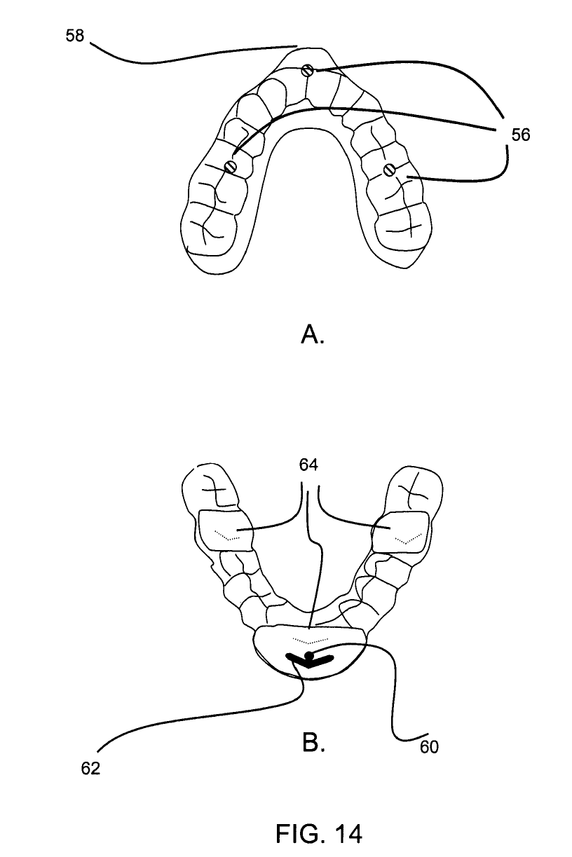

At a step 1612, the user creates contact surfaces on the lower offset piece, and at step 1614, the user creates contact spheres on the upper offset piece. In one example, and as recited in FIG. 16, three contact surfaces and three contact spheres are used. Later when the upper and lower devices are physically manufactured and worn on the teeth, the contact surfaces on the lower device interface with the contact spheres on the upper device. As discussed below with reference to step 1622, these contact points help make the device comfortable by reducing fatigue. These contact spheres and surfaces are also discussed relative to FIGS. 14A and 14B below.

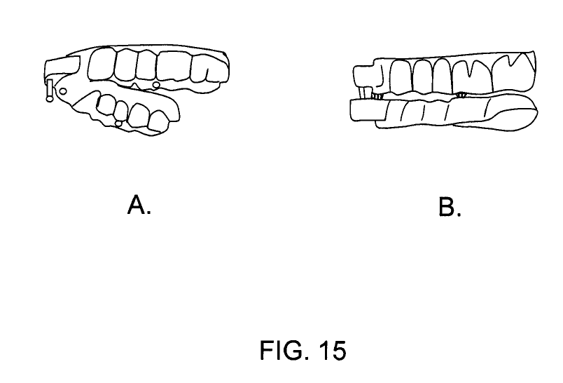

At step 1616, an anterior extrusion for a guide pin is created on the upper offset. This anterior extrusion, with the guide pin (referenced by the numeral 58) is shown on an exemplary finished device in FIGS. 14A and 15A. The anterior extrusion acts as a support for the guide pin 58, which is used to connect the upper and lower portions of the device when worn by a patient.

At a step 1618, Boolean operations are used to cut the upper and lower casts from their respective offsets. This leaves the lower offset with the impressions of the lower teeth and the upper offset with the impressions of the upper teeth. These impressions are intended to and shaped to receive the patients actual teeth when worn. The impressions in the offsets have a depth suitable to secure the actual teeth into the offset to hold the actual teeth and jaw in the protrusive position discussed with reference to step 1602.

At step 1620, the user may use digital movement data to move the lower cast relative to the upper cast. These movements may follow the pre-determined pathways of movement which may be the actual recorded or calculated movements of the jaw for the actual patient, as discussed above with reference to step 620 in FIG. 6.

At step 1622, the user may use the virtual movement and Boolean operations to cut contact surfaces in harmony with movement of the guide pin and the contact spheres on the lower jaw. This may include creating non-planar topography, having curves or features that rise and fall with the side-to-side or other movement of the upper jaw relative to the lower jaw. This is done to promote continuous contact between the contact spheres on the upper offset and the contact surfaces on the lower offset even when the jaw is moved side-to-side. This provides more even loading of the jaws, and less muscle fatigue and discomfort of the jaw while a patient sleep, while still holding the jaw in the protrusive position.

At a step 1624, the upper cast, lower cast and offsets are saved as an .stl file (3D data file). At a step 1626, the 3D data file is sent via the Internet to an separate location, such as a separate laboratory or dentist, for evaluation and changes if needed. In some exemplary embodiments, the file is not sent to an offsite location, but is stored for access by a remote user, such as the laboratory or dentist. This access may be made using for example, the Internet or other network. Accordingly, at step 1626, the data is made available to an additional user for review and editing.

At step 1628, after review and approval by the dentist, the .stl file of the offsets are sent to a manufacturing facility to make the actual device. The actual manufacturing may be accomplished using any suitable method, but in some embodiments, may be manufactured using programmable CNC machinery, such as a computer controlled mill, or using layered manufacturing (rapid prototyping). Once properly manufactured according to the specifications of the .stl file, the device is shipped to the dentist for patient treatment at step 1630.

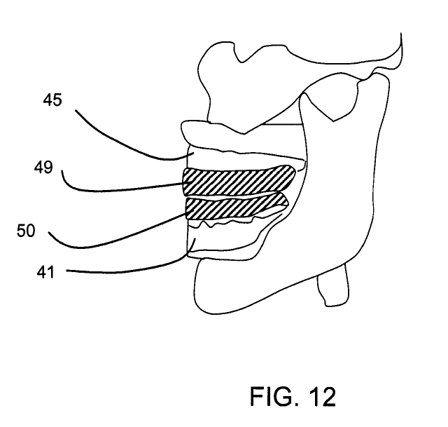

FIG. 12 is an illustration of the virtual model of the patient in a protrusive position of the mandible recorded with the CT bite plate. A 1-2 mm offset is created in the software to create the form of the upper offset 49 and lower 50 offset. Boolean operations are used to cut the shape of the upper 45 and lower 41 cast from each offset piece. This virtual planning provides an opportunity to determine if adequate space is present between the teeth and where the components of the sleep apnea device should be placed. A critical aspect of design is a shape that is comfortable and still in harmony with the patient's jaw movement. Frequently, the position of the various components may need to be changes to create comfort.

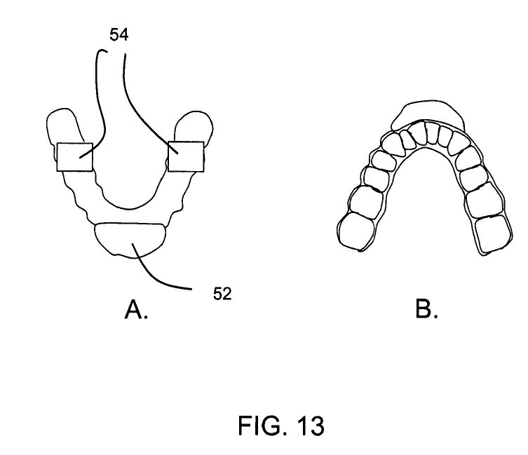

FIG. 13 is an illustration of a top view of a lower offset piece (FIG. 13A) and a bottom view of the lower offset piece (FIG. 13B). An anterior contact surface 52 and two posterior contact surfaces 54 provide occlusal support for the opposing contact spheres on the upper offset piece. Although the anterior contact surface 54 is shown anterior of the line of teeth, in other embodiments, the anterior contact surface may be disposed posterior of the line of teeth, such as at the bottom of the U-shaped offset portion. This may enable the anterior contact surface to better fit within a patient's mouth.

FIG. 14 is an illustration of the upper offset piece (FIG. 14A) and lower offset piece (FIG. 14B). The upper offset piece has three spheres 56 added to provide contacting points for the lower contacting surfaces. In addition a guide pin 58 is also attached to retain the mandible in an anterior position even with functional movements. A circular hole 60 is present in the anterior guide surface for the ball of the guide pin to insert into. A V shaped opening 62 is cut into the anterior contact surface using Boolean operations and the data to control movement of the mandible and lower offset piece. The shape of the V is unique to each patient, and called the “Gothic Arch.” By cutting a shape that is in harmony with the patient's condylar movements, the patient is much more comfortable when wearing the device. The V shaped opening prevents the mandible from moving posterior to the close the pharyngeal airway. Three other “Gothic Arch” shapes are created by again moving the mandibular virtual model using motion data to create the path of the spheres 56 in the anterior 52 and posterior 54 contact surfaces. These are also three-dimensional surfaces unique to each patient and they provide support for the mandible when it is moved side to side.

FIG. 15A is a side view of the upper virtual offset piece with the guide pin and FIG. 15B shows the guide pin inserted into the lower offset piece. Once the design of the device has been created it can then be sent via the Internet to any clinician involved in treatment to confirm the proper design. Once the final design has been confirmed the device can be created using computer controlled milling or layered manufacturing. Since it is desirable that the device be thin and very comfortable, creating the device in metal using direct metal manufacturing is a preferred embodiment. The direct metal melting processes use laser or electron beam technology to melt powdered metal a layer at a time.

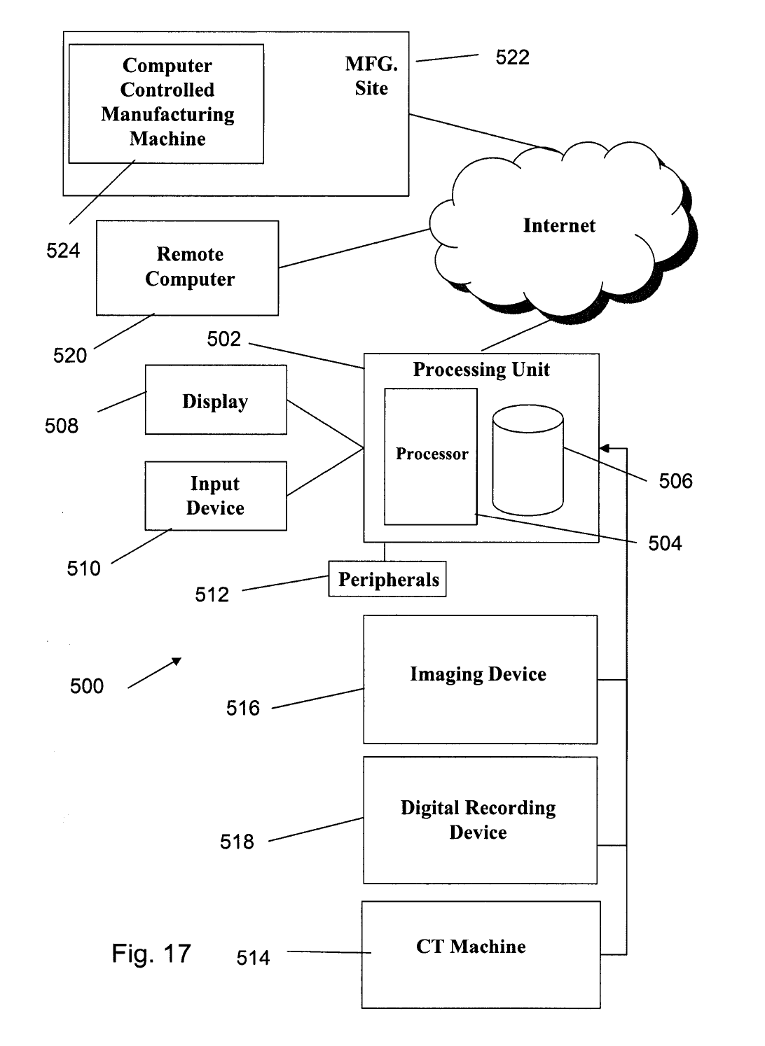

An exemplary system for performing the processes and methods described herein is shown in FIG. 17. FIG. 17 includes a computer system 500 including a processing unit 502 containing a processor 504 and a memory 506. An output device, such as a display 508 and input devices 510, such as keyboards, scanners, and others, are in communication with the processing unit 502. Additional peripheral devices 512 also may be present.

The processor 504 may for example be a microprocessor of a known type. The memory 506 may, in some embodiments, collectively represents two or more different types of memory. For example, the memory 506 may include a read only memory (ROM) that stores a program executed by the processor 504, as well as static data for the processor 504. In addition, the memory 506 may include some random access memory (RAM) that is used by the processor 504 to store data that changes dynamically during program execution. The processor 504 and the memory 506 could optionally be implemented as respective portions of a known device that is commonly referred to as a microcontroller. The memory 506 may contain one or more executable programs to carry out the methods contained herein, including joining, separating, storing, and other actions including Boolean actions.

The system 500 also may include a CT machine 514, an imaging device 516, and a digital recorder 518. These may be any of the CT machines, imaging devices, and digital recorders described herein. Data from the CT machine 514, the imaging device 516, and the digital recorder 518 may be accessed by the processing unit 502 and used to carry out the processes and methods disclosed. Data may be communicated to the processing unit 502 by any known method, including by direct communication, by storing and physically delivering, such as using a removable disc, removable drive, or other removable storage device, over e-mail, or using other known transfer systems over a network, such as a LAN or WAN, including over the internet or otherwise. Any data received at the processing unit 502 may be stored in the memory 506 for processing and manipulation by the processor 504. In some embodiments, the memory 506 is a storage database separate from the processor 504.

As shown, the processing unit 502 is connected to a WAN, disclosed herein as the Internet. Using the Internet, the processing unit 502 can communicate data, including .stl files showing modeled data for manufacture to either a remote computer 520 or a manufacturing site 522, which in this embodiment includes a computer controlled manufacturing machine 524, which may be, for example, an NC mill or layered manufacturing machine. Other machines also are contemplated. Using the Internet, data may be sent from the processing unit 502 to the remote computer 520 or the manufacturing site 522. In one example, the remote computer may be a dentist's or other provider's computer. Using the remote computer, the provider may access the images on the processing unit 502 (or alternatively receive and store a local copy) and may modify or edit the images as desired. Once edits or modifications are made the revised data may be sent back to the processing unit 502, or alternatively, may be sent directly to the manufacturing site. Once the manufacturing site 522 receives the data, it may be used to program the computer controller manufacturing machine 524 to create the intra oral devices.

In one exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth. The method also may include creating a virtual intra oral device interfacing with the teeth of the first virtual model, the virtual intra oral device having impressions formed therein to match the teeth of the first virtual model. The method also may include creating an actual intra oral device based on the virtual intra oral device.

In another aspect, the creating the virtual intra oral device may include: creating an offset from the first virtual model of the patient's teeth; and cutting the first virtual model of the patient's teeth from the offset with a Boolean operation to form the impressions in the offset and to create the intra oral device from the offset. In another aspect, the method may include shaping the offset piece using Boolean operations to have a smooth outer surface. In another aspect, the method may include: creating a second virtual model of the patient's teeth, the second virtual model being the other of a model of the patient's upper teeth and a model of the patient's lower teeth; and forming indents shaped to match the teeth of the second virtual model in the virtual intra oral device on a side opposite the impressions. In another aspect, the impressions are sized and shaped to secure the intra oral device to the teeth, and the indents are sized and shaped to not secure the virtual intra oral device to the teeth. In another aspect, the method may include: creating a second virtual model of the patient's teeth, the second virtual model being the other of a model of the patient's upper teeth and a model of the patient's lower teeth; and digitally moving the second virtual model relative to the virtual intra oral device along a pre-determined path of movement. In another aspect, digitally moving the second virtual model relative to the virtual intra oral device along a pre-determined path of movement indicates whether the intra oral device will comfortably fit the patient's mouth. In another aspect, the method may include: creating a second virtual model of the patient's teeth, the second virtual model being the other of a model of the patient's upper teeth and a model of the patient's lower teeth; and creating a second virtual intra oral device interfacing with the teeth of the second virtual model, the second virtual intra oral device having impressions formed therein to match the teeth of the second virtual model; generating a virtual support for a connector on the first virtual intra oral device; and wherein creating an actual intra oral device includes manufacturing a first and a second actual intra oral device based respectively on the first and second virtual intra oral devices, the support being manufactured to permit a connector to connect to both the first and the second virtual intra oral devices. In another aspect, the method may include: creating a second virtual model of the patient's teeth, the second virtual model being the other of a model of the patient's upper teeth and a model of the patient's lower teeth; creating a second virtual intra oral device interfacing with the teeth of the second virtual model, the second virtual intra oral device having impressions formed therein to match the teeth of the second virtual model; and editing the first virtual intra oral device to include contact surfaces. In another aspect, the method may include editing the second virtual intra oral device to include contact protrusions sized and shaped to interface with the contact surfaces. In another aspect, editing the first virtual intra oral device to include contact surfaces includes forming the contact surfaces to have a curvature that permits continuous contact between the contact surfaces and the contact protrusions during movement of the first virtual model relative to the second virtual model along a pre-determined path of movement. In another aspect, editing the first virtual intra oral device to include contact surfaces includes determining the travel path of the upper teeth relative to the lower teeth for the patient and creating the contact surfaces to have a curvature matching the travel path of the upper teeth relative to the lower teeth to promote contact along the surfaces when the upper teeth move relative to the lower teeth. In another aspect, the method may include transmitting computer readable data representative of the virtual intra oral device to a manufacturing site; and wherein creating an actual intra oral device based on the virtual intra oral device includes manufacturing an actual intra oral device based on the computer readable data. In another aspect, the method may include including permitting a remote computer user to access and modify the virtual intra oral device image.

In another exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth, and may include creating a virtual intra oral device interfacing with the teeth of the first virtual model of the patient's teeth, the virtual intra oral device having impressions formed therein to match the teeth of the first virtual model. Computer readable data representative of the virtual intra oral device may be transmitted to a manufacturing site; an actual intra oral device may be created based on the computer readable data.

In one aspect, the method may include permitting a remote computer user to access and modify the virtual intra oral device image. In one aspect, permitting a remote computer user to access and modify includes permitting a treating care provider at a remote site to access and modify the virtual intra oral device image. In one aspect, permitting a remote computer user to access and modify includes: transmitting a computer file over the internet from a sender's location so that the computer can locally access and modify the virtual intra oral device image; and transmitting the modified image as data to the sender's location. In one aspect, permitting a remote computer user to access and modify includes permitting the remote user to remotely access the virtual intra oral device over the internet and modify the virtual intra oral device.

In another exemplary aspect, this disclosure is directed to a method of manufacturing an intra oral device for a patient. The method may include creating a first virtual model of the patient's teeth, the first virtual model being one of a model of the patient's upper teeth and a model of the patient's lower teeth; creating a first virtual intra oral device interfacing with the teeth of the first virtual model, the virtual intra oral device having impressions formed therein to match the teeth of the first virtual model; creating a second virtual model of the patient's teeth, the second virtual model being the other of a model of the patient's upper teeth and a model of the patient's lower teeth; and creating a second virtual intra oral device interfacing with the teeth of the second virtual model, the second virtual intra oral device having impressions formed therein to match the teeth of the second virtual model; generating a virtual support for a connector on the first virtual model; and creating a first and a second actual intra oral device based respectively on the first and second virtual intra oral devices, the support being created to permit the connector to connect to both the first and the second intra oral devices.

In one aspect, creating the first virtual intra oral device includes: creating a first offset from the first virtual model of the patient's teeth; cutting the first virtual model of the patient's teeth from the offset to form the impressions in the first offset, the offset being the first virtual intra oral device; and wherein creating the second virtual intra oral device includes: creating a second offset from the second virtual model of the patient's teeth; cutting the second virtual model of the patient's teeth from the second offset to form the impressions in the second offset, the offset being the second virtual intra oral device. In one aspect, the method may include modifying the first virtual intra oral device to include contact surfaces; and modifying the second virtual intra oral device to include contact protrusions sized and shaped to interface with the contact surfaces. In one aspect, the method may include modeling the pharyngeal airway to determine whether the first and second intra oral devices aid in treating sleep apnea.

In another exemplary aspect, this disclosure is directed to a device for treatment of sleep apnea. The device may include an upper piece shaped to securely receive upper teeth; a lower piece shaped to securely receive lower teeth; a connector extending from the upper piece to the lower piece, the connector being configured to limit the range of movement of the upper teeth relative to the lower teeth and to urge the lower teeth into a protrusive position relative to the upper teeth.

In one aspect, the device may include a plurality of contact surfaces on the lower piece; and a plurality of spherical shaped protrusions on the upper piece, the protrusions facing the contact surfaces on the lower piece, wherein the contact surfaces have a single divot formed therein for receiving the spherical shaped protrusions when the teeth are aligned, and wherein the contact surfaces have a topography that promotes contact between the protrusions and the surfaces when the upper teeth move relative to the lower teeth; and wherein each of the upper piece and the lower piece includes a protruding support for receiving the connector.

Although several selected embodiments have been illustrated and described in detail, it will be understood that they are exemplary, and that a variety of substitutions and alterations are possible without departing from the spirit and scope of the present invention, as defined by the following claims. Further, it is contemplated that features disclosed in any one embodiment, system, or method may be used on any other embodiment, system, or method.

I claim:

1. A method of manufacturing an intra oral device for a patient, comprising:
creating a first virtual model of the patient's teeth, the first virtual model being one of a model of the patient's upper teeth and a model of the patient's lower teeth;
creating a virtual intra oral device interfacing with the teeth of the first virtual model, the virtual intra oral device having impressions formed therein to match the teeth of the first virtual model; and
creating an actual intra oral device based on the virtual intra oral device.

2. The method of claim 1, wherein creating the virtual intra oral device includes:
creating an offset from the first virtual model of the patient's teeth; and
cutting the first virtual model of the patient's teeth from the offset with a Boolean operation to form the impressions in the offset and to create the intra oral device from the offset.

3. The method of claim 2, including shaping the offset piece using Boolean operations to have a smooth outer surface.

4. The method of claim 1, including:
creating a second virtual model of the patient's teeth, the second virtual model being the other of a model of the patient's upper teeth and a model of the patient's lower teeth; and
forming indents shaped to match the teeth of the second virtual model in the virtual intra oral device on a side opposite the impressions.

5. The method of claim 1,
wherein the impressions are sized and shaped to secure the intra oral device to the teeth, and
wherein the indents are sized and shaped to not secure the virtual intra oral device to the teeth.

6. The method of claim 1, including:
creating a second virtual model of the patient's teeth, the second virtual model being the other of a model of the patient's upper teeth and a model of the patient's lower teeth;
digitally moving the second virtual model relative to the virtual intra oral device along a pre-determined path of movement.

7. The method of claim 6, wherein digitally moving the second virtual model relative to the virtual intra oral device along a pre-determined path of movement indicates whether the intra oral device will comfortably fit the patient's mouth.

8. The method of claim 1, including:
creating a second virtual model of the patient's teeth, the second virtual model being the other of a model of the patient's upper teeth and a model of the patient's lower teeth; and
creating a second virtual intra oral device interfacing with the teeth of the second virtual model, the second virtual intra oral device having impressions formed therein to match the teeth of the second virtual model;
generating a virtual support for a connector on the first virtual intra oral device; and
wherein creating an actual intra oral device includes manufacturing a first and a second actual intra oral device based respectively on the first and second virtual intra oral devices, the support being manufactured to permit a connector to connect to both the first and the second virtual intra oral devices.

9. The method of claim 1, including:
creating a second virtual model of the patient's teeth, the second virtual model being the other of a model of the patient's upper teeth and a model of the patient's lower teeth;
creating a second virtual intra oral device interfacing with the teeth of the second virtual model, the second virtual intra oral device having impressions formed therein to match the teeth of the second virtual model; and
editing the first virtual intra oral device to include contact surfaces.

10. The method of claim 9, including editing the second virtual intra oral device to include contact protrusions sized and shaped to interface with the contact surfaces.

11. The method of claim 10, wherein editing the first virtual intra oral device to include contact surfaces includes forming the contact surfaces to have a curvature that permits continuous contact between the contact surfaces and the contact protrusions during movement of the first virtual model relative to the second virtual model along a pre-determined path of movement.

12. The method of claim 9, wherein editing the first virtual intra oral device to include contact surfaces includes determining the travel path of the upper teeth relative to the lower teeth for the patient and creating the contact surfaces to have a curvature matching the travel path of the upper teeth relative to the lower teeth to promote contact along the surfaces when the upper teeth move relative to the lower teeth.

13. The method of claim 1, including:
transmitting computer readable data representative of the virtual intra oral device to a manufacturing site; and
wherein creating an actual intra oral device based on the virtual intra oral device includes manufacturing an actual intra oral device based on the computer readable data.

14. The method of claim 1, including permitting a remote computer user to access and modify the virtual intra oral device image.

15. A method of manufacturing an intra oral device for a patient, comprising:
creating a first virtual model of the patient's teeth, the first virtual model being one of a model of the patient's upper teeth and a model of the patient's lower teeth;
creating a virtual intra oral device interfacing with the teeth of the first virtual model of the patient's teeth, the virtual intra oral device having impressions formed therein to match the teeth of the first virtual model;
transmitting computer readable data representative of the virtual intra oral device to a manufacturing site; and
creating an actual intra oral device based on the computer readable data.

16. The method of claim 15, including permitting a remote computer user to access and modify the virtual intra oral device image.

17. The method of claim 16, wherein permitting a remote computer user to access and modify includes permitting a treating care provider at a remote site to access and modify the virtual intra oral device image.

18. The method of claim 16, wherein permitting a remote computer user to access and modify includes:
transmitting a computer file over the internet from a sender's location so that the computer can locally access and modify the virtual intra oral device image; and
transmitting the modified image as data to the sender's location.

19. The method of claim 16, wherein permitting a remote computer user to access and modify includes permitting the remote user to remotely access the virtual intra oral device over the internet and modify the virtual intra oral device.

20. A method of manufacturing an intra oral device for a patient, comprising:
creating a first virtual model of the patient's teeth, the first virtual model being one of a model of the patient's upper teeth and a model of the patient's lower teeth;
creating a first virtual intra oral device interfacing with the teeth of the first virtual model, the virtual intra oral device having impressions formed therein to match the teeth of the first virtual model;
creating a second virtual model of the patient's teeth, the second virtual model being the other of a model of the patient's upper teeth and a model of the patient's lower teeth; and
creating a second virtual intra oral device interfacing with the teeth of the second virtual model, the second virtual intra oral device having impressions formed therein to match the teeth of the second virtual model;
generating a virtual support for a connector on the first virtual model; and
creating a first and a second actual intra oral device based respectively on the first and second virtual intra oral devices, the support being created to permit the connector to connect to both the first and the second intra oral devices.

21. The method of claim 20, wherein creating the first virtual intra oral device includes:
creating a first offset from the first virtual model of the patient's teeth;
cutting the first virtual model of the patient's teeth from the offset to form the impressions in the first offset, the offset being the first virtual intra oral device;
and wherein creating the second virtual intra oral device includes:
creating a second offset from the second virtual model of the patient's teeth;
cutting the second virtual model of the patient's teeth from the second offset to form the impressions in the second offset, the offset being the second virtual intra oral device.

22. The method of claim 20, including:
modifying the first virtual intra oral device to include contact surfaces; and
modifying the second virtual intra oral device to include contact protrusions sized and shaped to interface with the contact surfaces.

23. The method of claim 20, including modeling the pharyngeal airway to determine whether the first and second intra oral devices aid in treating sleep apnea.

24. A device for treatment of sleep apnea, comprising:
an upper piece shaped to securely receive upper teeth;
a lower piece shaped to securely receive lower teeth;
a connector extending from the upper piece to the lower piece, the connector being configured to limit the range of movement of the upper teeth relative to the lower teeth and to urge the lower teeth into a protrusive position relative to the upper teeth.

25. The device of claim 24, comprising:
a plurality of contact surfaces on the lower piece; and
a plurality of spherical shaped protrusions on the upper piece, the protrusions facing the contact surfaces on the lower piece,
wherein the contact surfaces have a single divot formed therein for receiving the spherical shaped protrusions when the teeth are aligned, and wherein the contact surfaces have a topography that promotes contact between the protrusions and the surfaces when the upper teeth move relative to the lower teeth; and wherein each of the upper piece and the lower piece includes a protruding support for receiving the connector.
